(19) United States
(12) Patent Application Publication
(10) Pub. No.: US 2013/0005181 A1
(43) Pub. Date: Jan. 3, 2013

(54) CABLE CONNECTION STRUCTURE

(75) Inventors: Junya YAMADA, Tokyo (JP); Mikio NAKAMURA, Tokyo (JP)

(73) Assignee: OLYMPUS CORPORATION, Tokyo (JP)

(21) Appl. No.: 13/613,912

(22) Filed: Sep. 13, 2012

Related U.S. Application Data
(63) Continuation of application No. PCT/JP2011/057030, filed on Mar. 23, 2011.

(30) Foreign Application Priority Data
Apr. 8, 2010 (JP) 2010-089788

(51) Int. Cl. H01R 9/05; H01R 13/40

(52) U.S. Cl. 439/578; 439/733.1

(57) ABSTRACT

A cable connection structure includes a cable that has an outer skin and at least one conducting wire, and a substrate to which the cable is connected at a main surface side having a hard wiring, wherein the substrate includes, at the main surface side, a first flat section having flatness and a second flat section having flatness thinner than the first flat section via a level difference surface from the first flat section and an end part of the outer skin is arranged on the second flat section and at least one of the conducting wire is connected to a connecting electrode formed on the second flat section.

### CROSS-REFERENCE TO RELATED APPLICATION

This application is a continuation of International Application No. PCT/JP2011/057030, designating the United States and filed on Mar. 23, 2011 which claims the benefit of priority of the prior Japanese Patent Application No. 2010-089788, filed on Apr. 8, 2010, and the entire contents of the International application and the Japanese Application are incorporated herein by reference.

### BACKGROUND OF THE INVENTION

1. Field of the Invention

The present invention relates to a cable connection structure in which a coaxial cable is connected to a substrate.

2. Description of the Related Art

As a structure for connecting a coaxial cable, a structure in which a slit is provided on an upper surface of a printed circuit substrate and a pattern for connection with an external conductor is formed at both sides of the slit has been known as disclosed in Japanese Patent Application Laid-Open No. 2001-68175. According to the technique disclosed in Japanese Patent Application Laid-Open No. 2001-68175, the external conductor of the coaxial cable is placed in the slit provided in the printed circuit substrate and can be connected to the pattern for connection at both sides of the slit, so that it is possible to make a height of an attachment of the coaxial cable low by a portion by which the external conductor drops in the slit.

### SUMMARY OF THE INVENTION

According to an aspect of the present invention, a cable connection structure includes a cable that has an outer skin and at least one conducting wire, and a substrate to which the cable is connected at a main surface side having a hard wiring, wherein the substrate includes, at the main surface side, a first flat section having flatness and a second flat section having flatness thinner than the first flat section via a level difference surface from the first flat section and an end part of the outer skin is arranged on the second flat section and at least one of the conducting wire is connected to a connecting electrode formed on the second flat section.

The above and other features, advantages, and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a partial cross sectional view of a cable connection structure according to a first embodiment;

FIG. 2 is a perspective view of a configuration of the substrate according to the first embodiment;

FIG. 3 is a partial cross sectional view of a cable connection structure according to a second embodiment;

FIG. 4 is a partial cross sectional view of a cable connection structure according to a third embodiment;

FIG. 5 is a partial cross sectional view of a cable connection structure according to a fourth embodiment;

FIG. 6 is a partial cross sectional view of a cable connection structure according to a fifth embodiment;

FIG. 7 is a partial cross sectional view of a cable connection structure according to a first modification of the fifth embodiment;

FIG. 8 is a partial cross sectional view of a cable connection structure according to a sixth embodiment;

FIG. 9 is a partial cross sectional view of a cable connection structure according to a first modification of the sixth embodiment; and

FIG. 10 is a partial cross sectional view of a cable connection structure according to a second modification of the sixth embodiment.

### DETAILED DESCRIPTION OF THE PREFERRED EMBODIMENTS

Exemplary embodiments of a cable connection structure according to the present invention will be explained below with reference to the accompanying drawings. It should be noted that the present invention is not limited to the embodiments. It should also be noted that the same part is assigned with the same reference symbol through the description of the drawings.

### First Embodiment

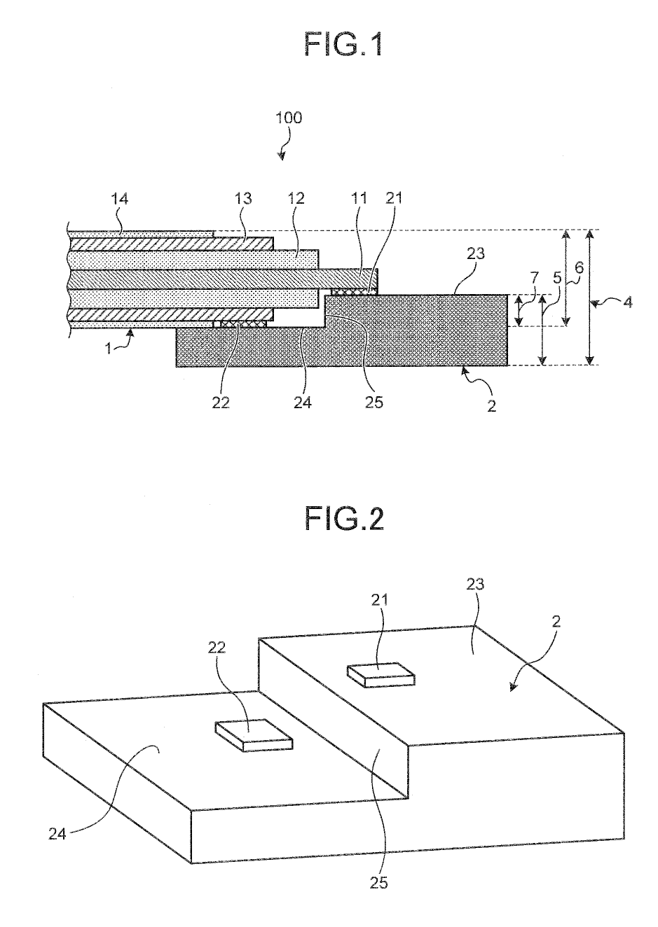

FIG. 1 is a partial cross sectional view of a cable connection structure 100 according to a first embodiment. FIG. 2 is a perspective view of a configuration of a substrate 2 to which a coaxial cable 1 is connected by the cable connection structure 100 according to the first embodiment. The cable connection structure 100 is provided with the coaxial cable 1 and the substrate 2 to which the coaxial cable 1 is connected as shown in FIG. 1.

The coaxial cable 1 is provided with a center conductor 11 as a core wire, an internal insulator 12 provided in an outer circumference of the center conductor 11, an external conductor 13 as a shielding wire that covers an outer circumference of the internal insulator 12, and an outer insulator 14 provided in an outer circumference of the external conductor 13.

The substrate 2 is provided with a first flat section 23 having flatness and a second flat section 24 that has a surface flush with the first flat section 23 and has flatness whose thickness is less than that of the first flat section 23 as shown in FIG. 2. A level difference surface 25 formed in a boundary between the first flat section 23 and the second flat section 24 is formed perpendicularly to a main surface of the first flat section 23 and a main surface of the second flat section 24. In other words, the first flat section 23 and the second flat section 24 are formed via the level difference surface 25. Besides, a center conductor connecting electrode 21 to which an end part of the center conductor 11 is connected is formed on the main surface of the first flat section 23 and an external conductor connecting electrode 22 to which an end part of the external conductor 13 is connected is formed on the main surface of the second flat section 24.

The level difference surface 25 of the substrate 2 is formed by performing a process such as an etching only on a predetermined area of a predetermined surface of the substrate 2. After forming the level difference surface 25, the external conductor connecting electrode 22 is formed on the main surface of the second flat section 24 and the center conductor connecting electrode 21 is formed on the main surface of the first flat section 23. In the case of forming the level difference surface 25 by etching and the like, a silicon substrate is preferably used.

For the substrate 2, a ceramic substrate and the like may be applied and the level difference surface 25 in a ceramic substrate is formed by laminating ceramic layers only at a predetermined area of a predetermined surface of the substrate 2.

Then, the end part of the center conductor 11 of the coaxial cable 1 and the center conductor connecting electrode 21, and the end part of the external conductor 13 and the external conductor connecting electrode 22 are electrically and mechanically connected by using a conductive bonding member, not shown, such as a solder, an anisotropically-conductive film (ACF), and an anisotropically-conductive paste (ACP).

As explained so far, the coaxial cable 1 and the substrate 2 are connected by arranging the conductive bonding member such as a solder, bonding the end part of the center conductor 11 of the coaxial cable 1 and the center conductor connecting electrode 21 formed on the main surface of the first flat section 23 of the substrate 2, and bonding the end part of the external conductor 13 and the external conductor connecting electrode 22 formed on the main surface of the flat section 24 in the cable connection structure 100 according to the first embodiment. Thus, it is possible to reduce a height 4 of the attachment part of the coaxial cable 1 with respect to the substrate 2 in the cable connection structure 100 by a height 7 of the level difference surface 25 of the substrate 2 from a total height of a thickness 5 of the first flat section 23 of the substrate 2 and a diameter 6 of the coaxial cable 1.

Thanks to the effect in the cable connection structure 100 according to the first embodiment, it becomes possible to suppress an increase in the height 4 of the attachment part of the coaxial cable 1 and connect the coaxial cable 1 to the substrate 2. Specifically, it is possible to reduce the height 4 of the attachment part of the coaxial cable 1 by the height 7 of the level difference surface 25. Therefore, it is possible to suppress an increase, associated with the connection of the coaxial cable 1, in the direction of the thickness of the substrate 2. The cable connection structure 100 can be applied to a connection between an ultrasonic transducer of an ultrasonic endoscope and a coaxial cable, for example.

### Second Embodiment

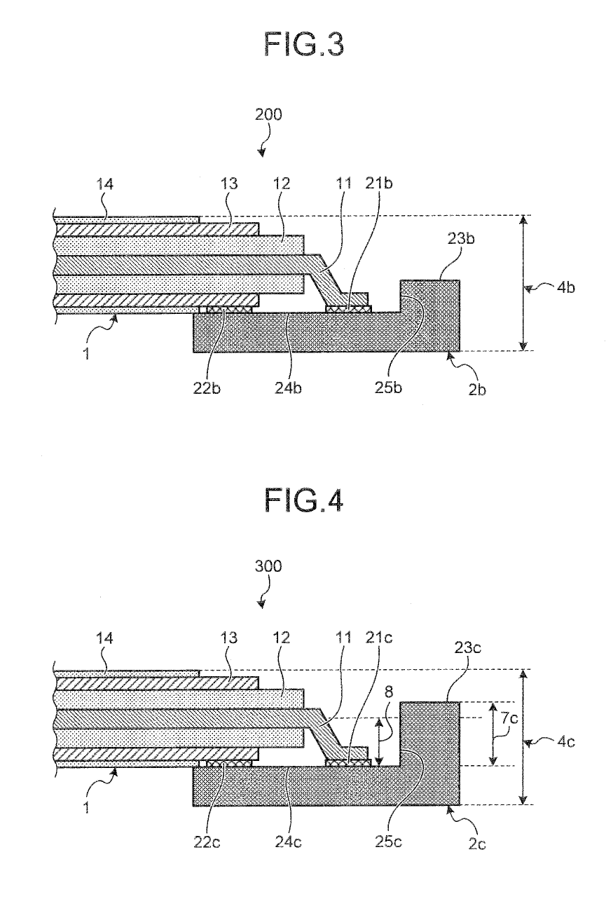

FIG. 3 is a partial cross sectional view of a cable connection structure 200 according to a second embodiment. In FIG. 3, the same part as the first embodiment is assigned with the same reference symbol. As shown in FIG. 3, a center conductor connecting electrode 21b of a substrate 2b is formed on a main surface of a second flat section 24b in the cable connection structure 200 according to the second embodiment.

The coaxial cable 1 and the substrate 2b are electrically and mechanically connected by a conductive bonding member, not shown, such as a solder and an ACF similarly to the first embodiment. Specifically, the end part of the center conductor 11 of the coaxial cable 1 and the center conductor connecting electrode 21b, and the end part of the external conductor 13 and an external conductor connecting electrode 22b are electrically and mechanically connected by a conductive bonding member, not shown, such as a solder, an ACF, and an ACP.

As explained so far, it is possible in the cable connection structure 200 according to the second embodiment to obtain the same effect as the first embodiment. Besides, since the center conductor connecting electrode 21b of the substrate 2b is formed on the main surface of the second flat section 24b, it is possible to connect the coaxial cable 1 to the substrate 2b by using a general cable connection method of connecting a cable to a flat substrate surface.

Thanks to the effect, it is possible in the cable connection structure 200 according to the second embodiment to obtain the same advantageous effects as the first embodiment. In addition, since a center conductor connecting part (the center conductor 11 and the center conductor connecting electrode 21b) and an external electrode connecting part (the external electrode 13 and the external conductor connecting electrode 22b) are placed on the same main surface of the second flat section 24b and thereby there is no difference in heating conditions in connection due to the formation of respective connecting electrodes on different flat sections or no necessity of taking a difference in shape of connection parts into consideration, it is possible to realize a joint at the same time in the same process by using conventional cable connecting methods and to make the connection of the coaxial cable 1 to the substrate 2b easy. The cable connection structure 200 can be applied to a connection between an ultrasonic transducer of an ultrasonic endoscope and a coaxial cable, for example.

### Third Embodiment

FIG. 4 is a partial cross sectional view of a cable connection structure 300 according to a third embodiment. In FIG. 4, the same part as the first and the second embodiments is assigned with the same reference symbol. As shown in FIG. 4, a level difference surface 25c between a first flat section 23c and a second flat section 24c of a substrate 2c has a height equal to or more than a radius of the coaxial cable 1 in the cable connection structure 300 according to the third embodiment.

The coaxial cable 1 and the substrate 2c are electrically and mechanically connected by a conductive bonding member, not shown, such as a solder and an ACF similarly to the first and the second embodiments. Specifically, the end part of the center conductor 11 of the coaxial cable 1 and a center conductor connecting electrode 21c, and the end part of the external conductor 13 and an external conductor connecting electrode 22c are electrically and mechanically connected by a conductive bonding member, not shown, such as a solder, an ACF, and an ACP.

As explained so far, it is possible in the cable connection structure 300 according to the third embodiment to obtain the same effect as the first and the second embodiments. Besides, since a height 7c of the level difference surface 25c between the first flat section 23c and the second flat section 24c of the substrate 2c is configured to be equal to or more than a radius 8 of the coaxial cable 1, it is possible to reduce a height 4c of the attachment part of the coaxial cable 1 to the substrate 2c by not less than the radius 8 of the coaxial cable 1.

Thanks to the effect, it is possible in the cable connection structure 300 according to the third embodiment to obtain the same advantageous effects as the first and the second embodiments. In addition, it is possible to make the height 4c of the cable attachment in the cable connection structure 300 according to the third embodiment substantially less than the cable attachment height in conventional techniques. Specifically, it is only possible in the conventional techniques to reduce the attachment height of the coaxial cable 1 to such a degree as to be less than the depth of the slit or less than the radius of the external conductor and moreover it is impossible to realize a reduction to such a degree as to be equal to or more than the radius of the coaxial cable. This is because there is a necessity of making the slit equal to or more than the diameter of the external conductor to reduce the cable attachment height by not less than the radius of the external conductor in the conventional techniques and it is impossible in that case to connect the external conductor with no contact on the substrate. In the third embodiment, it is possible to easily obtain a good connection since the attachment height of the coaxial cable 1 can be reduced substantially by making the height 7c of the level difference surface 25c between the first flat section 23c and the second flat section 24c of the substrate 2c equal to or more than the radius 8 of the coaxial cable 1 and besides there is no possibility that a contact area between the end part of the external conductor 13 of the coaxial cable 1 and the external conductor contacting electrode 22c becomes small. The cable connection structure 300 can be applied to a connection between an ultrasonic transducer of an ultrasonic endoscope and a coaxial cable, for example.

### Fourth Embodiment

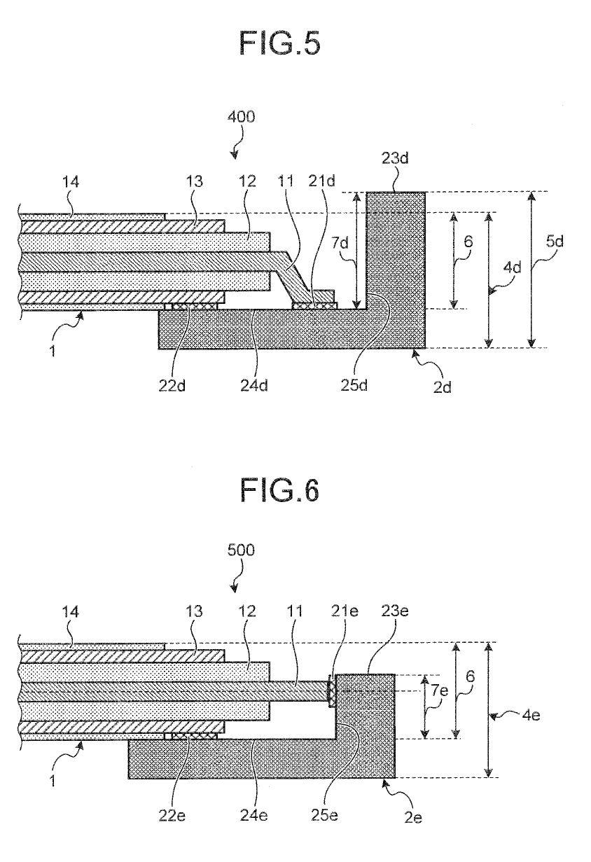

FIG. 5 is a partial cross sectional view of a cable connection structure 400 according to a fourth embodiment. In FIG. 5, the same part as the first to the third embodiments is assigned with the same reference symbol. As shown in FIG. 5, a height 7d of a level difference surface 25d between a first flat section 23d and a second flat section 24d of a substrate 2d is equal to or more than the diameter 6 of the coaxial cable 1 in the cable connection structure 400 according to the fourth embodiment.

The coaxial cable 1 and the substrate 2d are electrically and mechanically connected by a conductive bonding member, not shown, such as a solder and an ACF similarly to the first to the third embodiments. Specifically, the end part of the center conductor 11 of the coaxial cable 1 and a center conductor connecting electrode 21d, and the end part of the external conductor 13 and an external conductor connecting electrode 22d are electrically and mechanically connected by a conductive bonding member, not shown, such as a solder, an ACF, and an ACP.

As explained so far, it is possible in the cable connection structure 400 according to the fourth embodiment to obtain the same effect as the first to the third embodiments. Besides, since the height 7d of the level difference surface 25d between the first flat section 23d and the second flat section 24d of the substrate 2d is configured to be equal to or more than the diameter 6 of the coaxial cable 1, it is possible to suppress a height 4d of the attachment part of the coaxial cable 1 to the substrate 2d to such a degree as to be not more than a thickness 5d of the first flat section 23d of the substrate 2d.

Thanks to the effect explained above, it is possible in the cable connection structure 400 according to the fourth embodiment to obtain the same advantageous effects as the first to the third embodiments. In addition, since the height 7d of the level difference surface 25d of the substrate 2d is configured to be not less than the diameter 6 of the coaxial cable 1, it is possible to make the height 4d of the attachment part of the coaxial cable 1 to the substrate 2d less than the thickness 5d of the first flat section 23d of the substrate 2d and to connect the coaxial cable 1 to the substrate 2d without causing an increase in the height 4d of the attachment part. The cable connection structure 400 can be applied to a connection between an ultrasonic transducer of an ultrasonic endoscope and a coaxial cable, for example.

### Fifth Embodiment

FIG. 6 is a partial cross sectional view of a cable connection structure 500 according to a fifth embodiment. In FIG. 6, the same part as the first to the fourth embodiments is assigned with the same reference symbol. As shown in FIG. 6, the cable connection structure 500 according to the fifth embodiment is configured such that a height 7e of a level difference surface 25e between a first flat section 23e and a second flat section 24e of a substrate 2e is equal to or less than the diameter 6 of the coaxial cable 1. As shown in FIG. 6, a center conductor connecting electrode 21e is formed on the level difference surface 25e (vertical surface) of the substrate 2e in the coaxial cable connection structure 500 according to the fifth embodiment.

The coaxial cable 1 and the substrate 2e are electrically and mechanically connected by a conductive bonding member, not shown, such as a solder and an ACF similarly to the first to the fourth embodiments. Specifically, the end part of the center conductor 11 of the coaxial cable 1 and the center conductor connecting electrode 21e, and the end part of the external conductor 13 and an external conductor connecting electrode 22e are electrically and mechanically connected by a conductive bonding member, not shown, such as a solder, an ACF, and an ACP.

As explained so far, it is possible in the cable connection structure 500 according to the fifth embodiment to obtain the same effect as the first embodiment. Specifically, it is possible to reduce a height 4e of the attachment part of the coaxial cable 1 by the height 7e of the level difference surface 25e. In addition, there becomes no necessity of forming the center conductor connecting electrode 21e on a main surface of the first flat section 23e and a main surface of the second flat section 24e.

Thanks to the effect explained above, it is possible in the cable connection structure 500 according to the fifth embodiment to obtain the same advantageous effects as the first embodiment. In addition, it is possible to make an area of the first flat section 23e and the second flat section 24e small since the center conductor connecting electrode 21e is arranged on the level difference surface 25e of the substrate 2e and there becomes no necessity of forming the center conductor connecting electrode 21e on the main surface of the first flat section 23e and the main surface of the second flat section 24e. Therefore, it is possible to make a dimension, necessary for connecting the coaxial cable 1 to the substrate 2e, of the substrate 2e in a longitudinal direction of the coaxial cable 1 small. The cable connection structure 500 can be applied to a connection between an ultrasonic transducer of an ultrasonic endoscope and a coaxial cable, for example.

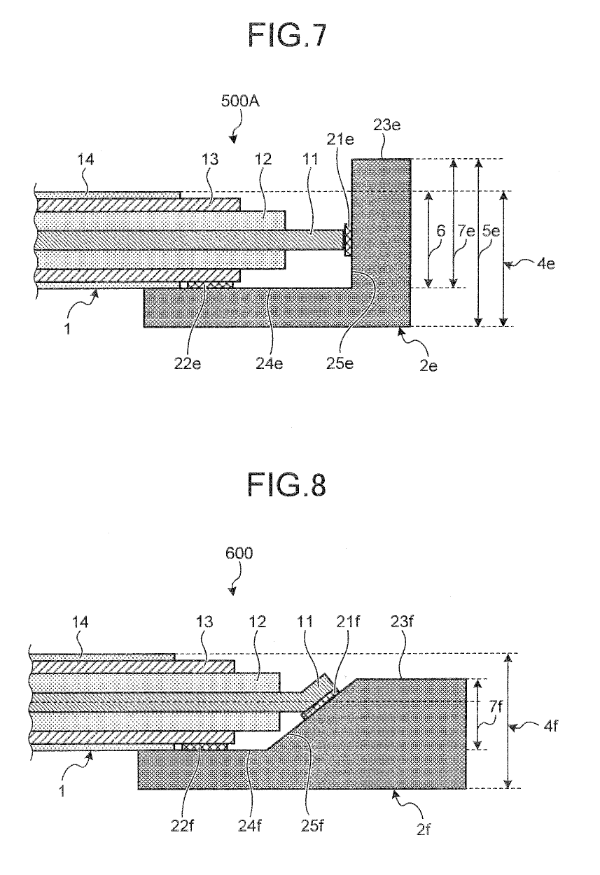

Besides, a cable connection structure 500A in which the height 7e of the level difference surface 25e between the first flat section 23e and the second flat section 24e of the substrate 2e is configured to be equal to or more than the diameter 6 of the coaxial cable 1 is taken as a first modification of the fifth embodiment. FIG. 7 is a partial cross sectional view explaining the cable connection structure 500A according to the modification of the fifth embodiment. As shown in FIG. 7, the center conductor connecting electrode 21e is formed on the level difference surface 25e (vertical surface) of the substrate 2e in the cable connection structure 500A according to the first modification of the fifth embodiment.

According to the first modification of the fifth embodiment, it is possible to make the height 4e of the attachment part of the coaxial cable 1 to the substrate 2e less than a thickness 5e of the first flat section 23e of the substrate 2e and to connect the coaxial cable 1 to the substrate 2e without causing an increase in the height 4e of the attachment part. In addition, it is possible to make the area of the first flat section 23e and the second flat section 24e small since the center conductor connecting electrode 21e is arranged on the level difference surface 25e of the substrate 2e and there becomes no necessity of forming the center conductor connecting electrode 21e on the main surface of the first flat section 23e and the main surface of the second flat section 24e. Therefore, it is possible to make the dimension, necessary for connecting the coaxial cable 1 to the substrate 2e, of the substrate 2e in the longitudinal direction of the coaxial cable 1 small.

### Sixth Embodiment

FIG. 8 is a partial cross sectional view of a cable connection structure 600 according to a sixth embodiment. In FIG. 8, the same part as the first to the fifth embodiments is assigned with the same reference symbol. As shown in FIG. 8, the cable connection structure 600 according to the sixth embodiment is configured such that a height 7f of a level difference surface 25f between a first flat section 23f and a second flat section 24f of a substrate 2f is equal to or less than the diameter of the coaxial cable 1. As shown in FIG. 8, the level difference surface 25f between the first flat section 23f and the second flat section 24f of the substrate 2f is formed as a slope surface not perpendicular to main surfaces of the first flat section 23f and the second flat section 24f in the cable connection structure 600 according to the sixth embodiment.

Here, the substrate 2f is assumed to be a silicon substrate and the level difference surface 25f is obtained as a slope surface by a process through an anisotropic etching of a predetermined side surface of the substrate 2f, for example. After forming the level difference surface 25f, an external conductor connecting electrode 22f is formed on the main surface of the second flat section 24f and a center conductor connecting electrode 21f is formed on the level difference surface 25f as a slope surface.

The substrate 2f is not limited to the case of being constituted by a silicon substrate, and a ceramic substrate and the like may be similarly applied. When a ceramic substrate is used for the substrate 2f, an electrode can be formed on the level difference surface 25f as a slope surface by laminating ceramic layers in which electrode layers are formed at an edge part.

The coaxial cable 1 and the substrate 2f are electrically and mechanically connected by a conductive bonding member, not shown, such as a solder and an ACF similarly to the first to the fifth embodiments. Specifically, the end part of the center conductor 11 of the coaxial cable 1 and the center conductor connecting electrode 21f, and the end part of the external conductor 13 and the external conductor connecting electrode 22f are electrically and mechanically connected by a conductive bonding member, not shown, such as a solder, an ACF, and an ACP.

As explained so far, it is possible in the cable connection structure 600 according to the sixth embodiment to obtain the same effect as the first embodiment. Specifically, it is possible to reduce a height 4f of the attachment part of the coaxial cable 1 by the height 7f of the level difference surface 25f. Therefore, it is possible to suppress an increase, associated with the connection of the coaxial cable 1, in the direction of the thickness of the substrate 2f. In addition, since the level difference surface 25f of the substrate 2f is configured not to be perpendicular but to be a slope surface and the center conductor connecting electrode 21f is arranged on the level difference surface 25f, it is possible to make a projection area of the center conductor connecting electrode 21f in the direction perpendicular to the main surface of the first flat section 23f and the main surface of the second flat section 24f small without making a connection area between the center conductor connecting electrode 21f and the end part of the center conductor 11 small.

Thanks to the effect explained above, it is possible in the cable connection structure 600 according to the sixth embodiment to obtain the same advantageous effects as the first embodiment. In addition, since it is possible to make the projection area in the direction perpendicular to the main surface of the first flat section 23f and the main surface of the second flat section 24f small without making an area of the center conductor connecting electrode 21f small, it is possible to make a dimension necessary for the connection small without changing a connectivity of the center conductor 11. The cable connection structure 600 can be applied to a connection between an ultrasonic transducer of an ultrasonic endoscope and a coaxial cable, for example. While the center conductor connecting electrode 21f and the end part of the center conductor 11 are connected via a circumference of the outer diameter of the center conductor 11 in the cable connection structure 600 according to the sixth embodiment as shown in FIG. 8, a distal end part of the center conductor 11 may be formed to have a slope surface whose inclination is substantially the same as that of the level difference surface 25f and the slope surface formed at the distal end of the center conductor 11 and the center conductor connecting electrode 21f on the level difference surface 25f may be connected by a conductive film and the like to connect the center conductor 11 and the center conductor connecting electrode 21f.

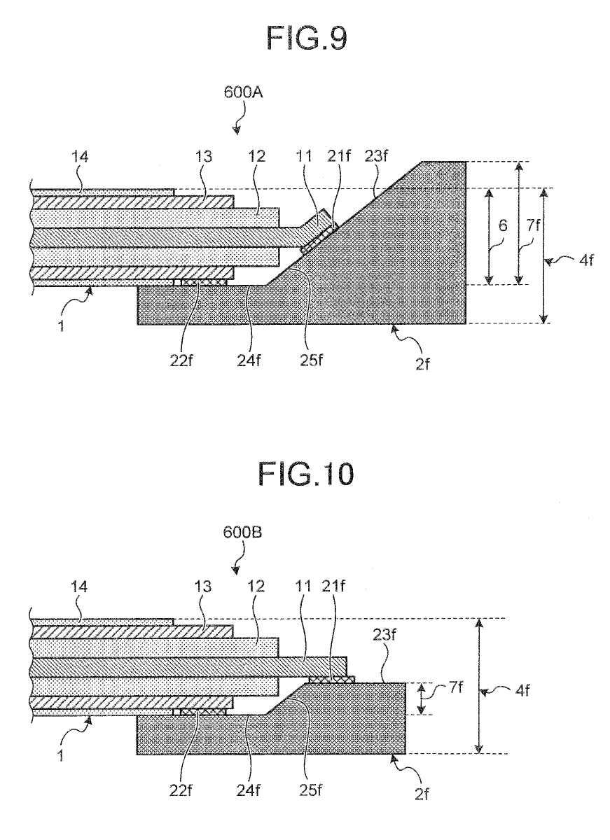

Besides, a cable connection structure 600A in which the height 7f of the level difference surface 25f between the first flat section 23f and the second flat section 24f of the substrate 2f is configured to be equal to or more than the diameter 6 of the coaxial cable 1 is taken as a first modification of the sixth embodiment. FIG. 9 is a partial cross sectional view of a cable connection structure 600A according to the first modification of the sixth embodiment. As shown in FIG. 9, the center conductor connecting electrode 21f is formed on the level difference surface 25f as a slope surface in the cable connection structure 600A according to the first modification of the sixth embodiment.

According to the first modification of the sixth embodiment, it is possible to make the height 4f of the attachment part of the coaxial cable 1 to the substrate 2f less than the thickness of the first flat section 23f of the substrate 2f and to connect the coaxial cable 1 to the substrate 2f without causing an increase in the height 4f of the attachment part since the height 7f of the level difference surface 25f is made more than the diameter 6 of the coaxial cable 1. In addition, since the level difference surface 25f of the substrate 2f is configured to be a slope surface which is not perpendicular to the main surfaces of the first flat section 23f and the second flat section 24f of the substrate 2f and the center conductor connecting electrode 21f is arranged on the level difference surface 25f, it is possible to make a projection area of the center conductor connecting electrode 21f in the direction perpendicular to the main surface of the first flat section 23f and the main surface of the second flat section 24f small without making a connection area of the end part of the center conductor 11 to the center conductor connecting electrode 21f small.

Moreover, a cable connection structure 600B in which the center conductor connecting electrode 21f is formed on the main surface of the first flat section 23f is taken as a second modification of the sixth embodiment. FIG. 10 is a partial cross sectional view of a cable connection structure 600B according to the second modification of the sixth embodiment. As shown in FIG. 10, the level difference surface 25f between the first flat section 23f and the second flat section 24f of the substrate 2f is formed as a slope surface with respect to the main surfaces of the first flat section 23f and the second flat section 24f in the cable connection structure 600B according to the second modification of the sixth embodiment.

According to the second modification of the sixth embodiment, it is possible to reduce the height 4f of the attachment part of the coaxial cable 1 by the height 7f of the level difference surface 25f.

While the case of connecting a coaxial cable to a substrate is exemplified in the embodiments explained above, the present invention is not limited to the embodiments and may be applied to a cable of other kinds except for the coaxial cable, for example, a cable in which one or more conducting wire is covered by an outer skin. In this case, by connecting at least one conducting wire to the second flat section as a thinner part of the substrate or the level difference surface, it is possible to connect the cable to the substrate with a reduction in height of the cable attachment part.

In the cable connection structure according to the present invention, there are advantageous effects in that a height of an attachment part of the cable to the substrate can be reduced by a height of the level difference surface formed in the substrate, or the cable can be connected to the substrate without causing an increase in height of the attachment part when the height of the level difference surface is more than a diameter of the cable.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A cable connection structure, comprising:
a cable that has an outer skin and at least one conducting wire; and
a substrate to which the cable is connected at a main surface side having a hard wiring, wherein
the substrate includes, at the main surface side, a first flat section having flatness and a second flat section having flatness thinner than the first flat section via a level difference surface from the first flat section and
an end part of the outer skin is arranged on the second flat section and at least one of the conducting wire is connected to a connecting electrode formed on the second flat section.

2. The cable connection structure according to claim 1, wherein the cable is a coaxial cable having a core wire and a shielding wire, and an end part of the shielding wire is connected to the connecting electrode formed on the second flat section.

3. The cable connection structure according to claim 1, wherein a height of the level difference surface is not less than a radius of the cable.

4. The cable connection structure according to claim 2, wherein a height of the level difference surface is not less than a radius of the cable.

5. The cable connection structure according to claim 3, wherein the height of the level difference surface is not less than a diameter of the cable.

6. The cable connection structure according to claim 4, wherein the height of the level difference surface is not less than a diameter of the cable.

7. The cable connection structure according to claim 1, wherein the level difference surface is perpendicular to the main surface of the first flat section and the second flat section.

8. The cable connection structure according to claim 1, wherein the level difference surface is a slope surface with respect to the main surface of the first flat section and the second flat section.

9. The cable connection structure according to claim 7, wherein
the cable is a coaxial cable having a core wire and a shielding wire and
an end part of the core wire is connected to a connecting electrode formed on the level difference surface.

10. The cable connection structure according to claim 8, wherein
the cable is a coaxial cable having a core wire and a shielding wire and
an end part of the core wire is connected to a connecting electrode formed on the level difference surface.

11. The cable connection structure according to claim 2, wherein an end part of the core wire is connected to the connecting electrode formed on the second flat section.
